(19) United States
(12) Patent Application Publication
(10) Pub. No.: US 2020/0123830 A1
(43) Pub. Date: Apr. 23, 2020

(54) SELF REGULATING COUNTERBALANCE MECHANISM WITH FRICTION

(71) Applicant: MAGNA CLOSURES INC., Newmarket (CA)

(72) Inventors: Joseph SCHEURING, Richmond Hill (CA); Wieslaw Nowicki, Mississauga (CA)

(21) Appl. No.: 16/660,138

(22) Filed: Oct. 22, 2019

Related U.S. Application Data
(60) Provisional application No. 62/748,847, filed on Oct. 22, 2018.

(51) Int. Cl. E05F 3/22; B60J 5/10

(52) U.S. Cl. CPC E05F 3/221; B60J 5/106; E05F 3/224; E05Y 2900/546; E05Y 2201/26; E05Y 2201/716; E05Y 2201/726; E05Y 2201/218

(57) ABSTRACT

A friction based counterbalance mechanism for coupling with a closure panel of a vehicle, the counterbalance mechanism including: a housing having a first pivot mount for connecting to one of a body of the vehicle and the closure panel; an extension member coupled to the housing and being extendable and retractable with respect to the housing, the extension member for connecting by a second pivot mount to the other of the body and the closure panel; a variable friction mechanism mounted in the housing having: a shaft having an axis; a washer positioned on the axis; a pinion with a friction body positioned on the shaft and adjacent to the washer, the pinion rotatable about the axis relative to the washer during rotation of the shaft to generate friction between the washer and the friction body; and a slider body positioned on the axis.

### CROSS-REFERENCE TO RELATED APPLICATION

This application claims priority from the benefit of the filing date of U.S. Provisional Patent Application No. 62/748,847 filed on Oct. 22, 2018, entitled “SELF REGULATING COUNTERBALANCE MECHANISM WITH FRICTION”, the contents of which are herein incorporated by reference.

### FIELD

This disclosure relates to a friction based counterbalance mechanism for a closure panel.

### BACKGROUND

Some vehicles are equipped with a closure panel, such as a lift gate, which is driven between an open position (position 2) and a closed position (position 1) using an electric drive system. Hold systems have been proposed to provide such vehicles with the capability of assisting the operator of the closure panel, in order to maintain a third position hold (or position 2) during opening and closing operations, so as to help counteract the weight of the closure panel itself. Without these hold systems, the closure panel may sag back down at the top end of the operational opening range due to the closure panel weight providing a closure torque greater than an opening torque provided by the electric drive system. Such proposed hold systems are, in some instances, complex and expensive and may not offer adequate failsafe modes (in the event of electric motor failure or loss of power) while at the same time maintaining adequate manual efforts by the operator. Also recognized is a need to provide an extension (e.g. actuated or counterbalance) mechanism that can be used to provide appropriate friction to the open/close operation of the closure panel.

Further disadvantages of current hold systems include bulky form factors which take up valuable vehicle cargo space, requirement to have additional lift support systems in tandem such as gas struts and other counterbalance mechanisms, unacceptable impact on manual open and close efforts requiring larger operator applied manual force at the panel handle, undesirable force spikes that do not provide for smoother manual force/torque curves, requirement to use vehicle battery power to maintain third position hold, and/or temperature effects resulting in variable manual efforts required by the operator due to fluctuations in ambient temperature.

It is recognized that constantly applied forces in a counterbalance mechanism can be problematic due to variations in the geometry and/or operator positioning during the complete raise and lowering cycle of a closure panel, including the ability to provide for third position hold where desired.

### SUMMARY

It is an object of the present invention to provide a variable friction mechanism for application in a counterbalance mechanism that obviates or mitigates at least one of the above presented disadvantages.

A first aspect provided is a friction based counterbalance mechanism for coupling with a closure panel of a vehicle to assist in opening and closing of the closure panel, the counterbalance mechanism including: a housing having a first pivot mount for connecting to one of a body of the vehicle and the closure panel; an extension member coupled to the housing and being extendable and retractable with respect to the housing, the extension member for connecting by a second pivot mount to the other of the body and the closure panel; a variable friction mechanism mounted in the housing having: a shaft having an axis; a washer positioned on the axis; a pinion with a friction body positioned on the shaft and adjacent to the washer, the pinion rotatable about the axis relative to the washer during rotation of the shaft to generate friction between the washer and the friction body; a slider body positioned on the axis; and a spring positioned on the axis between the slider body and the washer, such that the spring exerts an axial force on the washer to force the washer against the friction body; and a lead screw coupled to the extension member on one end and coupled to the shaft on the other end, such that extension and retraction of the extension member with respect to the housing causes rotation of the lead screw about the axis; wherein rotation of the lead screw causes rotation of the shaft to change an axial position of the slider body on the axis and thus a degree of compression of the spring positioned between the slider body and the washer.

A second aspect provided is a friction based counterbalance strut for coupling with a closure panel of a vehicle to assist in opening and closing of the closure panel, the counterbalance mechanism comprising: a housing connected to one of the closure panel or a body of the vehicle and having an inner surface bounding a cavity extending along a central axis between opposite first and second ends, the housing bounding a leadscrew disposed in said cavity and a planetary gearset disposed in said cavity and comprising an output coupled with said leadscrew and an input coupled with a friction body, the planetary gearset providing a gear reduction between said friction body and said leadscrew; a variable friction assembly disposed in said cavity and comprising a shaft extending between a first shaft end and a second shaft end, said first shaft end coupled to a slider body moveable axially along said central axis in response to rotation of said shaft and said second shaft end coupled to said leadscrew for corotation, and a friction member disposed between the slider body and the friction body; and a telescoping unit operably connected to the other of the closure panel or the body of the vehicle, said telescoping unit having an extensible tube at least partially received in said cavity through said second end of said housing and having a drive nut for converting linear motion of said telescoping unit between a retracted position relative to said housing and an extended position relative to said housing into rotary motion of said leadscrew, wherein rotation of the lead screw causes rotation of the shaft to change an axial position of the slider body to vary the friction the friction member generates against the friction body in response to a movement of the friction member imparted by the axial position change of the slider body.

A further aspect provided is a resilient element positioned between the slider body and the friction member of body, such that the resilient element exerts an axial force on the friction member to force the friction member against the friction body to generate friction between the friction member and the friction body wherein rotation of the lead screw causes rotation of the shaft to change an axial position of the slider body to vary the degree of compression of the resilient element.

A further aspect provided is a variable friction mechanism for mounting in a housing of a counterbalance mechanism for a closure panel of a vehicle, the variable friction mechanism including: a shaft having an axis; a friction member positioned on the axis; a pinion with a friction body positioned on the shaft and adjacent to the friction member, the pinion rotatable about the axis relative to the friction member during rotation of the shaft to generate friction between the friction member and the friction body; a slider body positioned on the axis; and a resilient element positioned on the axis between the slider body and the friction body, such that the resilient element exerts an axial force on the friction member to force the friction member against the friction body; wherein rotation of the shaft about the axis changes an axial position of the slider body on the axis and thus a degree of compression of the resilient element positioned between the slider body and the friction body.

A further aspect provided is a method for controlling movement of a closure panel of a vehicle between an open position and a closed position using a variable friction mechanism positioned in a counterbalance mechanism, the variable friction mechanism including a friction member positioned adjacent to a friction body, the method including the steps of: transforming rotary motion of a lead screw of the counterbalance mechanism into varying an applied bias of the friction member towards the friction body; increasing the bias of the friction member against the friction body in response to the rotary motion of said leadscrew in a first direction to increase a friction between the friction member and the friction body; and decreasing the bias of the friction member against the friction body in response to the rotary motion of said leadscrew in second direction opposite the first direction to decrease the friction between the friction member and the friction body.

Other aspects, including methods of operation, and other embodiments of the above aspects will be evident based on the following description and drawings.

### BRIEF DESCRIPTION OF THE DRAWINGS

Reference is made, by way of example only, to the attached figures, wherein:

FIG. 1 is a side view of a vehicle with a closure panel assembly;

FIG. 2 is an alternative embodiment of the vehicle of FIG. 1;

FIG. 3 shows an alternative embodiment of the vehicle with a closure panel assembly of FIG. 1;

FIGS. 4A to 4C is an example counterbalance mechanism with a variable friction mechanism for the closure panel in an open position shown in FIG. 1;

FIG. 5 is an exploded view of the variable friction mechanism of FIG. 4A;

FIG. 6 shows an enlarged section view of the variable friction mechanism shown in FIG. 4A;

FIG. 7 is an example counterbalance mechanism with the variable friction mechanism for the closure panel in the closed position shown in FIG. 1;

FIG. 8 shows an enlarged section view of the variable friction mechanism shown in FIG. 7;

FIG. 9 shows a perspective cross sectional view of the variable friction mechanism shown in FIG. 4A;

FIG. 10 is an alternative embodiment of the variable fiction mechanism of FIG. 8;

FIG. 11 is an alternative embodiment of the variable fiction mechanism of FIG. 6; and

FIGS. 12-14 show tables having various example friction values of the counterbalance mechanism of FIG. 4A; and

FIG. 15 illustrates an exemplary method of controlling movement of a closure panel of a vehicle between an open position and a closed position with a counterbalance strut of FIG. 1.

### DETAILED DESCRIPTION OF EXAMPLE EMBODIMENTS

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

### Closure Panel Assembly 12 Examples

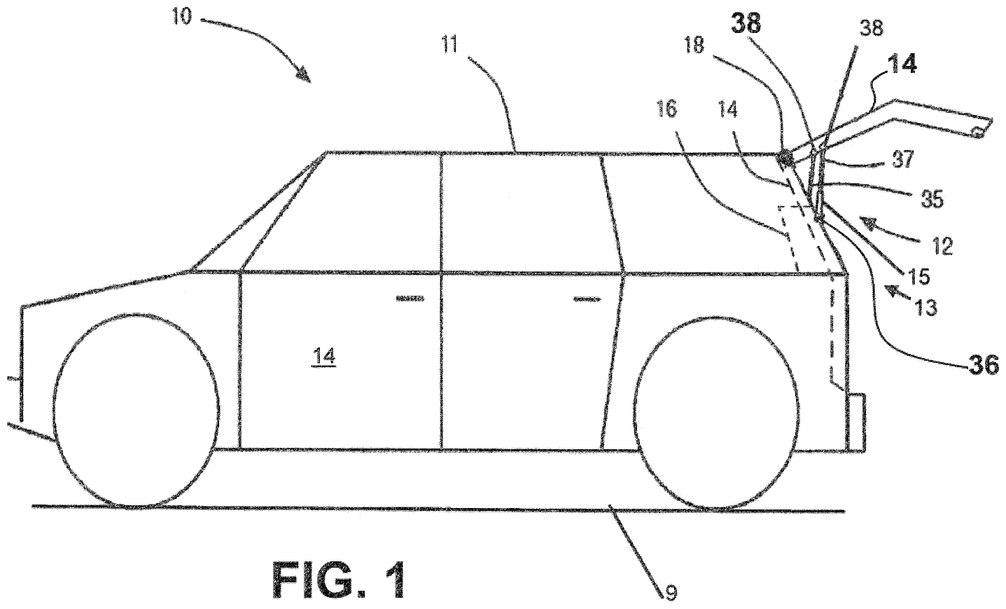

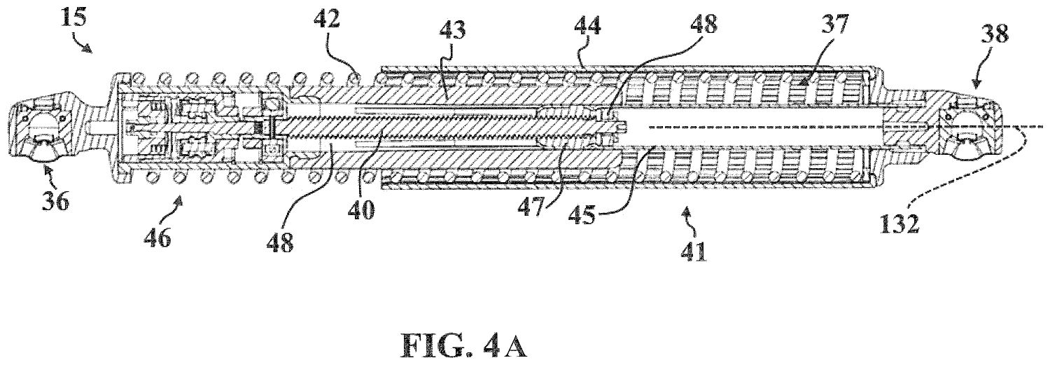

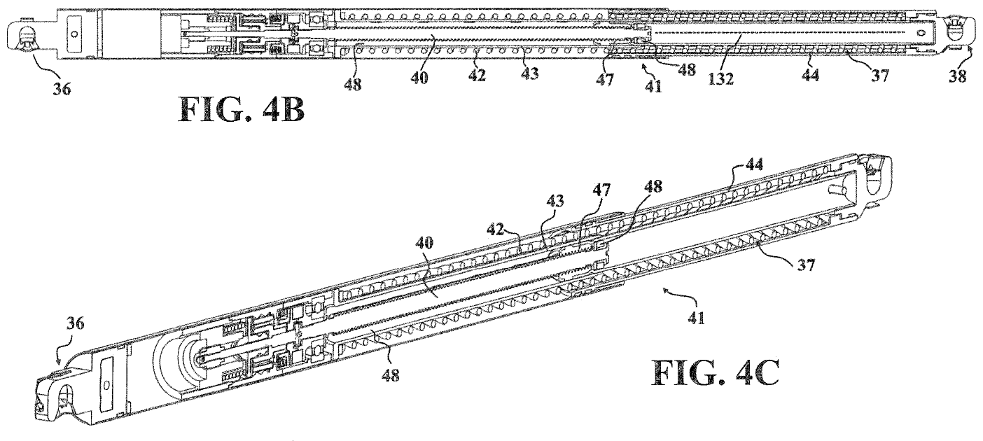

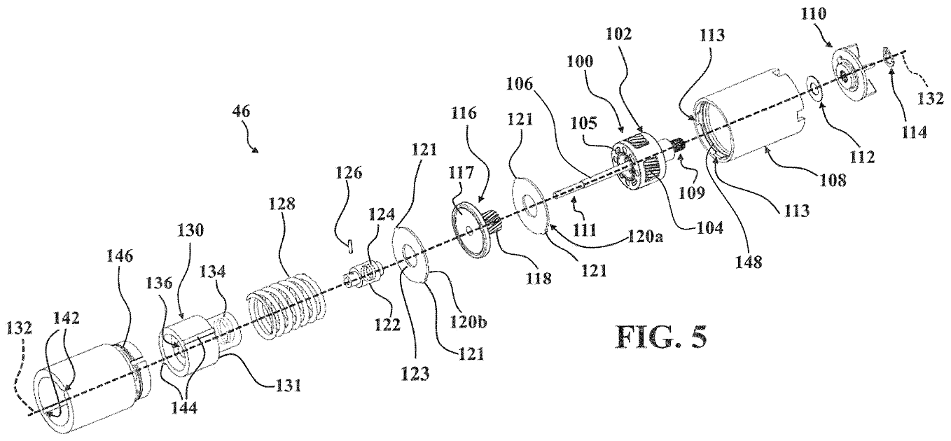

Provided is a counterbalance mechanism 15 (i.e. extension mechanism—see FIG. 1) that can be used advantageously with vehicle closure panels 14 to provide for open and close modes for operator assistance as discussed below, in particular for land-based, sea-based and/or air-based vehicles 10. Other applications of the counterbalance mechanism 15, in general for closure panels 14 both in and outside of vehicle applications, include advantageously assisting in optimization of overall hold and manual effort forces for closure panel 14 operation. It is recognized as well that the counterbalance mechanism 15 examples provided below can be used advantageously as the sole means of open and close assistance for closure panels 14 or can be used advantageously in combination (e.g. in tandem) with other closure panel 14 biasing members (e.g. spring loaded hinges, biasing struts, etc.). In particular, the counterbalance mechanism 15 can be friction assisted via one or more variable friction mechanisms 46 (see FIGS. 4 and 5) and used to provide or otherwise assist in a holding force (or torque) for the closure panel 14, as further described below. Further, it is recognized that the counterbalance mechanism can be integrated with a biasing member 37 (see FIGS. 1,4) such as a spring loaded strut and/or provided as a component of a closure panel assembly 12, as further described below. It is recognized that the biasing member 37, incorporating the counterbalance mechanism 15, can be implemented as a strut (see FIGS. 1,2,3 as example types of struts). The strut can be of a biasing type (e.g. spring and/or gas charge supplying the bias), can include a drive unit for example with a lead screw 40 (see FIGS. 4A to 4C) and/or as a counterbalance embodiment as shown. The strut can be of an electromechanical type (e.g. driven by an optional integrated motor assembly with spring and/or gas charge supplying a bias), as desired.

Referring to FIG. 1, shown is the vehicle 10 with a vehicle body 11 having one or more closure panels 14. One example configuration of the closure panel 14 is a closure panel assembly 12 including the counterbalance mechanism 15 (e.g. incorporated in a biasing member 37 embodied as a strut by example) and an optional closure panel drive system 16 (e.g. incorporating an electrically powered motor/drive). For vehicles 10, the closure panel 14 can be referred to as a partition or door, typically hinged, but sometimes attached by other mechanisms such as tracks, in front of an opening 13 which is used for entering and exiting the vehicle 10 interior by people and/or cargo. It is also recognized that the closure panel 14 can be used as an access panel for vehicle 10 systems such as engine compartments and also for traditional trunk compartments of automotive type vehicles 10. The closure panel 14 can be opened to provide access to the opening 13, or closed to secure or otherwise restrict access to the opening 13. It is also recognized that there can be one or more intermediate hold positions of the closure panel 14 between a fully open position and fully closed position, as provided at least in part by the counterbalance mechanism 15 as further described below. For example, the counterbalance mechanism 15 can assist in biasing movement of the closure panel 14 away from one or more intermediate hold position(s), also known as Third Position Hold(s) (TPHs) or Stop-N-Hold(s), once positioned therein. It is also recognized that the counterbalance mechanism 15 can be provided as a component of the closure panel assembly 12, such that the counterbalance mechanism 15 component can be separate from the one or more biasing members 37.

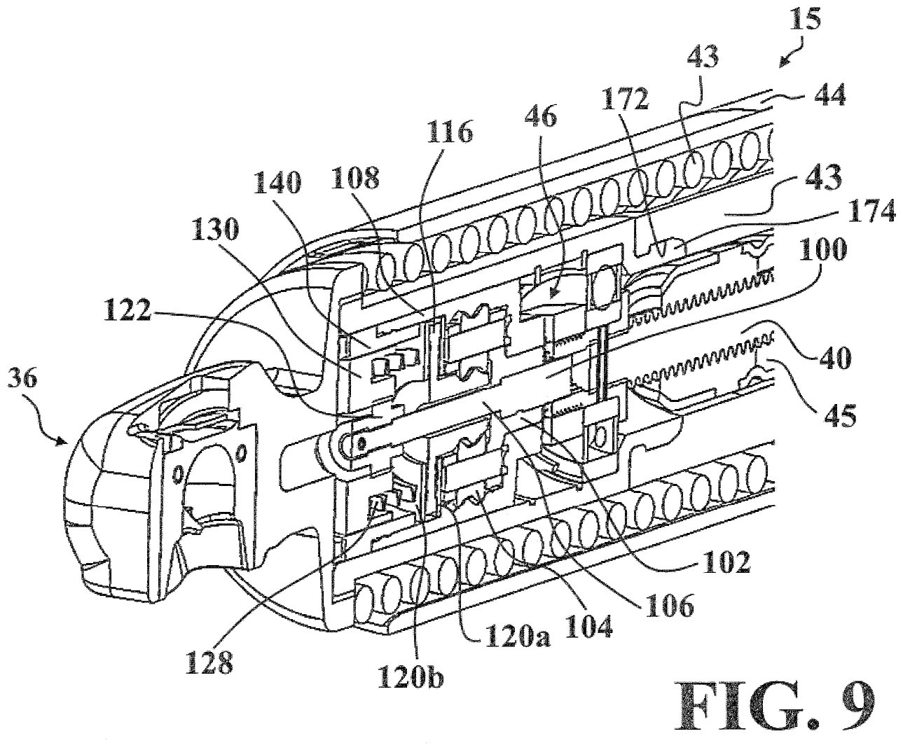

The closure panel 14 can be opened manually and/or powered electronically via the closure panel drive system 16, where powered closure panels 14 can be found on minivans, high-end cars, or sport utility vehicles (SUVs) and the like. Additionally, one characteristic of the closure panel 14 is that due to the weight of materials used in manufacture of the closure panel 14, some form of force assisted open and close mechanism (or mechanisms) can be used to facilitate operation of the open and close operation by an operator (e.g. vehicle driver) of the closure panel 14. The force assisted open and close mechanism(s) can be provided by the counterbalance mechanism 15, any biasing members 37 (e.g. spring loaded hinges, spring loaded struts, gas loaded struts, electromechanical struts, etc.) and/or the closure panel drive system 16 when used as part of the closure panel assembly 12, such that the counterbalance mechanism 15 is configured to provide a friction based holding torque (or force) (via the variable friction mechanism 46—see FIG. 4A) that acts against the weight of the closure panel 14 on at least a portion of the panel open/close path about the third position hold, in order to help maintain the position of the closure panel 14 about the third position hold. The ability to provide friction by the counterbalance mechanism 15 is facilitated by the variable friction mechanism 46 (see FIGS. 4, 9).

Referring to FIGS. 4A to 4C, it is recognized that a strut version of the counterbalance mechanism 15 can have a lead screw 40 operated either actively (i.e. driven) by a motor (e.g. electrical of the drive system 16) or operated passively such that the lead screw 40 is free to rotate about its longitudinal axis 132 but is not actively driven by a motor. It is recognized that a travel member 47 can be coupled to the lead screw 40, such that the travel member 47 is connected to an extension member 35 (e.g. solid rod, tube, etc.) connected to the closure panel 14. It can be the travel member 47 which is driven by extension and retraction of the extension member 35 with respect to a housing 41 of the counterbalance mechanism 15. As further discussed below, displacement of the travel member 47 along the longitudinal axis 132 is used to drive rotation of the lead screw 40.

It is recognized that the counterbalance mechanism 15 can be configured as an independent counterbalance mechanism for the closure panel 14 and/or can be configured as a component of the biasing member 37 (e.g. incorporated as an internal component of a strut).

### Closure Panel Assembly 12 Configuration

In terms of vehicles 10, the closure panel 14 may be a lift gate as shown in FIG. 1, or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening 13 in the body 11 of the vehicle 10. Also contemplated are sliding door embodiments of the closure panel 14 and canopy door embodiments of the closure panel 14, such that sliding doors can be a type of door that open by sliding horizontally or vertically, whereby the door is either mounted on, or suspended from a track that provides for a larger opening 13 for equipment to be loaded and unloaded through the opening 13 without obstructing access. Canopy doors are a type of door that sits on top of the vehicle 10 and lifts up in some way, to provide access for vehicle passengers via the opening 13 (e.g. car canopy, aircraft canopy, etc.). Canopy doors can be connected (e.g. hinged at a defined pivot axis and/or connected for travel along a track) to the body 11 of the vehicle at the front, side or back of the door, as the application permits.

Referring again to FIG. 1, in the context of a vehicle application of a closure panel by example only, the closure panel 14 is movable between a closed position (shown in dashed outline) and an open position (shown in solid outline). In the embodiment shown, the closure panel 14 pivots between the open position and the closed position about a pivot axis 18, which is preferably configured as horizontal or otherwise parallel to a support surface 9 of the vehicle 10. In other embodiments, the pivot axis 18 may have some other orientation such as vertical or otherwise extending at an angle outwards from the support surface 9 of the vehicle 10. In still other embodiments, the closure panel 14 may move in a manner other than pivoting, for example, the closure panel 14 may translate along a predefined track or may undergo a combination of translation and rotation between the open and closed position.

Referring again to FIG. 1, as discussed above, the counterbalance mechanism 15 examples provided below for the closure panel assembly 12 can be used as the sole means of open and close assistance for the inhibition of sag by the closure panels 14 themselves, or can be used in combination (e.g. in tandem or otherwise integrated) with one or more other closure panel biasing members 37 (e.g. spring loaded hinges, struts such as gas struts or spring loaded struts, etc.) that provide a primary connection of the closure panel 14 to the vehicle body 11 at pivot connections 36,38 (see FIG. 1). In general operation of the closure panel 14, the closure panel drive system 16 can be coupled to a distal end of the extension member 35 (also referred to as lever mechanism or arm or element) used to connect the closure panel 14 as a secondary connection of the closure panel to the vehicle body 11, such that the closure panel biasing member 37 and the extension member 35 can be pivotally attached to the closure panel 14 at spaced apart locations as shown. In this manner, the other end of the extension member 35 pivotally connects to the closure panel 14 at pivot connection 36. It is recognized that the extension member 35 itself can be configured as a non-biasing element (e.g. a solid rod) or can be configured as a biasing element (e.g. a gas or spring assisted extension strut), as desired.

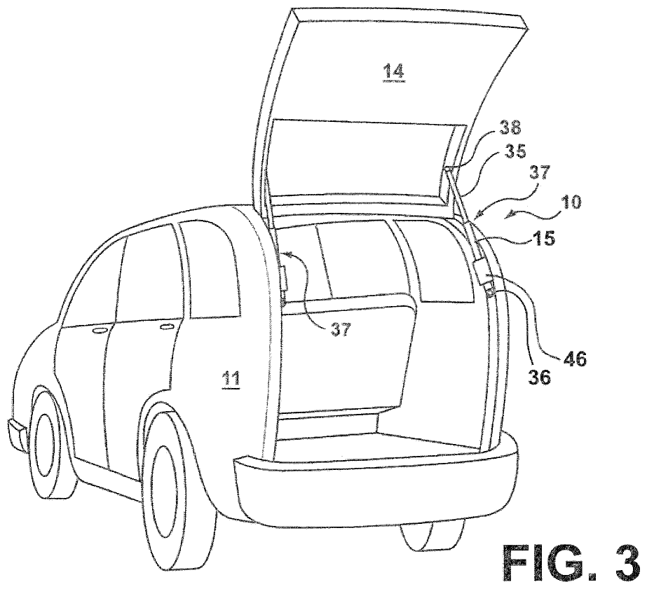

Referring again to FIG. 1, one or more optional closure panel biasing members 37 can be provided which urge the closure panel 14 towards the open position throughout at least some portion of the path between the open position and the closed position and which assist in holding the closure panel 14 in the open position. The closure panel biasing members 37 can be, for example, gas extension struts which are pivotally connected at their proximal end to the closure panel 14 and at their distal end to the vehicle body 11. In the embodiment shown, there are two biasing members 37 (one on the left side of the vehicle 10 and one on the right side of the vehicle 10), however one biasing member 37 is obscured by the other in the view shown. In one example, see FIG. 3, the counterbalance mechanism 15 can be coupled to the closure panel 14 on one side of the closure panel 14 as motorized biasing element 37, and the counterbalance mechanism 15 is incorporated at another side of the closure panel 14 in a differently configured biasing element 37, such that the counterbalance mechanism 15 is passively operated by motion of the closure panel 14.

As the closure panel 14 moves between the open and closed positions, the torques (or forces) exerted the on the closure panel 14 by the biasing members 37 and by the weight of the closure panel 14 itself will vary. In one embodiment, the closure panel 14 can have some position between the open and closed positions at which the torque (or force) exerted on the closure panel 14 by the biasing members 37 cancels out the torque (or force) exerted on the closure panel 14 by the weight of the closure panel 14 (i.e. the torque or force of the biasing member(s) 37 acts against the weight of the closure panel 14). Above this point (which can be referred to as a balance point or otherwise referred to as the intermediate hold position), the torque (or force) exerted by the biasing members 37 can overcome the torque (or force) exerted by the weight of the panel 14 thus resulting in a net torque (or force) away from the closed position, thus biasing the closure panel 14 towards the open position (i.e. the torque or force of the biasing member(s) 37 acts against the weight of the closure panel 14). Below this point, the torque (or force) exerted by the weight of the panel 14 can overcome the torque (or force) exerted by the biasing members 37 thus resulting in a net torque (or force) towards the closed position, thus biasing the closure panel 14 towards the closed position. However, even in travel of the closure panel 14 towards the closed position, the torque or force of the biasing member(s) 37 acts against the weight of the closure panel 14. In this manner, the effect of the biasing member(s) 37 is to provide a torque or force that always acts against the weight of the closure panel 14 (i.e. always supplies a closing torque or force). It is recognized that “3rd position hold” can also be referred to as an “intermediate hold position” or a “stop and hold position”.

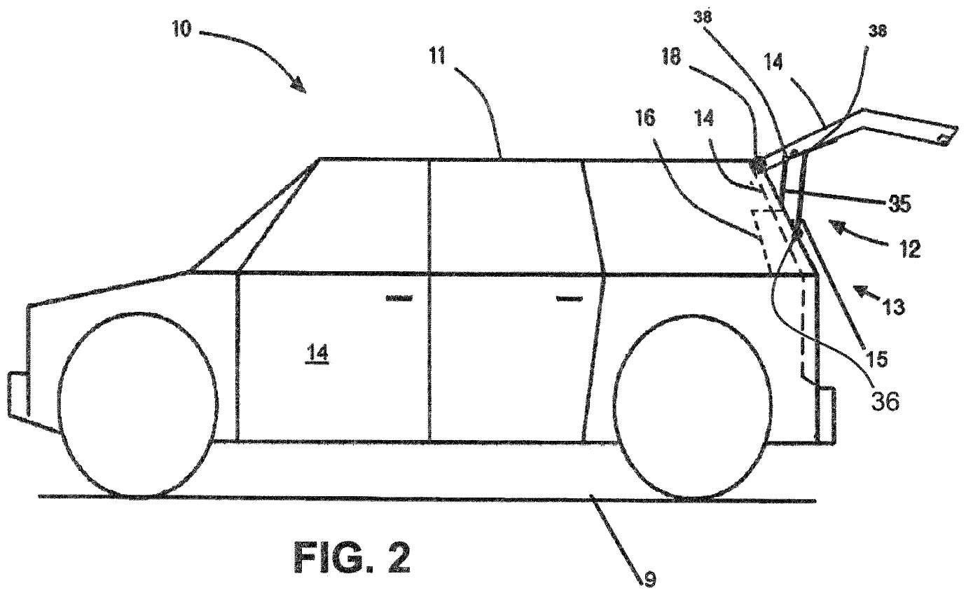

Further to operation of the above-described optional closure panel biasing members 37, one or more counterbalance mechanisms 15 can be provided in addition to (as shown in FIG. 1) or in substitution of (as shown in FIG. 2) the biasing members 37. For example, in terms of FIG. 1, one or more counterbalance mechanisms 15 can be provided which act to maintain or otherwise inhibit the closure panel 14 from travelling towards the closed position, i.e. assist in holding the closure panel 14 in the open position (e.g. intermediate hold positions and/or the fully open position). The one or more counterbalance mechanisms 15 can be, for example, coupled to or otherwise mounted on the vehicle body 11 and pivotally connected to the closure panel 14. In all cases, the counterbalance mechanism 15 contains the variable friction mechanism 46, as further described below.

### Variable Friction Mechanism 46

Referring to FIGS. 4 and 5, shown is the variable friction mechanism 46 having a carrier assembly 100 containing a carrier 102 with gears 104 (e.g. planetary gears) mounted thereon via pins 105. The carrier 102 is mounted on a shaft 106. The carrier assembly 100 is mounted within a ring gear 108 (e.g. part of planetary gears). A sprag 110 with washer 112 and clip 114 is used to couple the carrier assembly 100 to one end of the ring gear 108, such that the sprag 110 is coupled to end 109 of the shaft 106. The ring gear 108 can have anti-rotation slots 113 to inhibit rotation of the ring gear 108 as the shaft 106 rotates (further described below). A pinion 116 containing gear 118 (e.g. engaged with planetary gear set) and friction body 117 is mounted on the shaft 106, such that the gear 118 engages gears 104 of the carrier assembly 100. Washers 120a,b are positioned on either side of the friction body 117. Anti-rotation tabs 121 can be positioned on the washers 120a,b in order to inhibit rotation of the washers 120a,b as the shaft 106 rotates. A threaded coupling 122 having threads 124 is mounted on the other end 111 of the shaft 106 via pin 126, thus maintaining the position of the pinion 116 in the carrier assembly 100. A spring 128 (e.g. resilient element), such as a metal spring for example, is positioned between a slider body 130 and the washer 120b (e.g. friction member), such that the spring 128 is in a compressed/expanded state depending upon an axial position of the slider body 130 along axis 132 with respect to the washer 120b. Other types of resilient element may be provided such as a resilient pad of polymeric or rubber material for example and without limitation. As such, it is recognized that a degree of compression/expansion of the spring 128 depends upon the space (being variable) between a shoulder 131 of the slider body 130 and the opposing face 123 of the washer 120b. The resilient element 128 is used to bias the friction member 120b against the friction body 117 in order to generate friction there between. In another configuration, the resilient element 128 may not be provided and the slider body 130 urges, for example directly urges, the friction member 120b against the friction body 117 in order to generate friction there between. Movement of the friction member 120b to or from causes a change in the degree of engagement of the friction member against the friction body and the amount of friction force applied to the friction body 117 which effects the resistance to rotation of the friction body 117. The degree of such generated friction imparting a resistance to rotation of the shaft 106 may be multiplied e.g. increased through the speed reduction stage or torque increasing stage for example as provided by the gears 104, such as a planetary gear stage. In one configuration the degree of engagement of the friction member against the friction body may be continuous and the amount of force applied between by friction member against the friction body is variable in response to the position of the closure member between the open and closed position. Therefore friction may always be provided for between the friction member against the friction body and only the amount of friction between friction member against the friction body is varied, such as for example a minimum amount of friction is provided for when the closure member is in the closed position where at the moment arms may be the greatest and the influence of the friction acting on the friction body is desired to be minimal to minimize the opening forces required to move the closure member from the closed position towards the open position, an increasingly amount of friction is provided for when the closure member is moving towards the open position, and a maximum amount of friction is provided for when the closure member is in the open position where at the moment arms may be the lowest and the influence of the friction acting on the friction body is desired to be maximal to minimize the opening forces required to move the closure member from the closed position towards the open position. In another configuration, the degree of engagement of the friction member against the friction body may be discontinuous, for example and the amount of force applied between by friction member against the friction body is variable in response to the position of the closure member between the open and closed position. Therefore friction may be provided for between the friction member against the friction body and the amount of friction between friction member against the friction body is varied and the friction member may disengaged from the friction body such that no friction is generated by the friction member against the friction body, such as for example no amount of friction is provided for when the closure member is in the closed position where at the moment arms may be the greatest and the influence of the friction acting on the friction body is not required to thereby minimize the opening forces required to move the closure member from the closed position towards the open, an increasingly amount of friction is provided for when the closure member is moving towards the open position, and a maximum amount of friction is provided for when the closure member is in the open position where at the moment arms may be the lowest and the influence of the friction acting on the friction body is desired to be maximal to minimize the opening forces required to move the closure member from the closed position towards the open position. Other configurations of changes in the degree of friction may be provided, such as a linear change in friction between the closure member open and closed position, a non-linear change in friction, a generation of friction commencing only at a closure member position corresponding to a point of opening of the closure member, for example at a mid-point in travel between the open and closed positions, as examples only. The degree of engagement of the friction member 120b against the friction body 117 in accordance with an example is greater when the closure panel 14 is in an open position than when the closure panel 14 is in a closed position. For example, the friction generated may be sufficient when the closure member 14 is open, such as fully open for example, to provide a Stop-&-Hold function e.g. the closure member 14 weight is balanced with the friction force such that the closure member 14 does not move when a moving force is not applied to the closure member 14. It is recognized that increasing or decreasing the bias of the resilient element 128 causes a corresponding increase or decrease in a magnitude of the friction being generated between the friction member 120b and the friction body 117.

Further, the threads 124 of the coupling 122 are engaged with corresponding threads 134 of the slider body 130, when the coupling 122 is mounted within the slider body 130 in cavity 136 (i.e. outer threads 124 of the coupling 122 mate with inner threads 134—shown in ghosted view—of the slider body 130). The slider body 140 and coupling 122 is an illustrative example of a rotary to linear convertor 99 having an input 101 coupled to the shaft 106 for receiving a rotation of the shaft 106 and an output 103 coupled to the friction member 120b for moving the friction member 120b, for example a linear or rectilinear movement, relative to the pinion 11 e.g. towards or away from in response to receiving the rotation at the input 101. The rotary to linear convertor 99 will transform the rotation of the shaft 106 into a linear motion, and according to one example by the rotation of a screw to cause a translation of a nut as illustratively provided for by the slider body 130 in threaded engagement with when the coupling 122. The variable friction mechanism 46 also can have a cover 140 having anti-rotation slots 142 for mating with anti-rotation ribs 144 of the slider body 130, in order to inhibit rotation of the slider body 130 during rotation of the shaft 106. The cover 140 couples to the ring gear 108, for example via retaining ring 146 for receiving in retaining slot 148. As further described below, rotation of the shaft 106 causes translation of the slider body 130 along the axis 132 (either towards or away from the washer 120b), in view of the interaction between the mated threads 124,134.

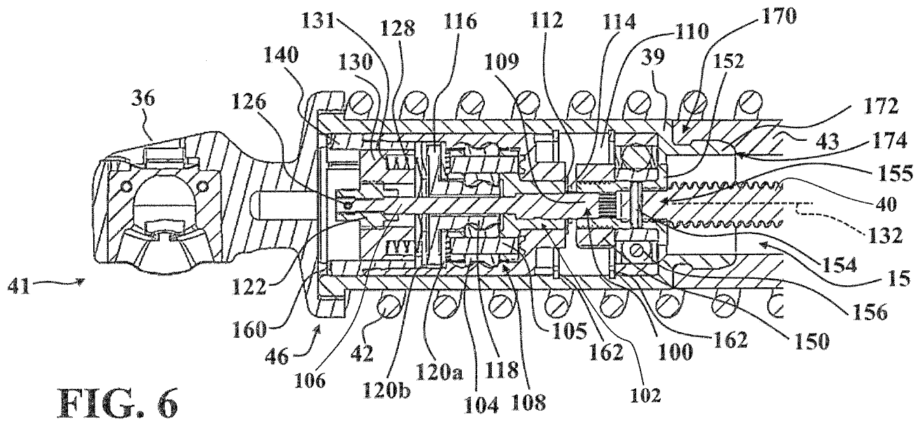

Referring to FIGS. 4 and 6, shown is the variable friction mechanism 46 connected to the counterbalance mechanism 15. The shaft 106 is coupled to the lead screw 40 at the end 109 (for conjoint rotation) via nut 150, locking nut 152 and pin 154. The nut 150, locking nut 152 and pin 154 can be collectively referred to as an adaptor 155 used to couple the lead screw 40 to the shaft 106 for conjoint rotation. A bearing 156 can be used to position the lead screw 40 and the shaft 106 along the axis 132 with respect to the ring gear 108. A gasket 160 can be used to seal the variable fiction mechanism 46 to a ball socket 36 portion of a housing 41 of the counterbalance mechanism 15, the housing 41 having a cavity 60 bounded by an inner surface 61. The other end of the housing 41 has a ball socket 38, such that one of the ball sockets 36,38 is used to couple the counterbalance mechanism 15 to the body 11 of the vehicle 10 and the other of the ball sockets 36,38 is used to couple the counterbalance mechanism 15 to the closure panel 14. Clips 162 (e.g. on either side of the sprag 110) can be used to fixedly position the variable friction mechanism on the axis 132 with respect to the housing 41. Also shown is a coupling 170 between a housing 39 of the variable friction mechanism 46 (e.g. positioned within the spring 42) and the spring support tube 43, for example via a recess 172 and tab 174 configuration.

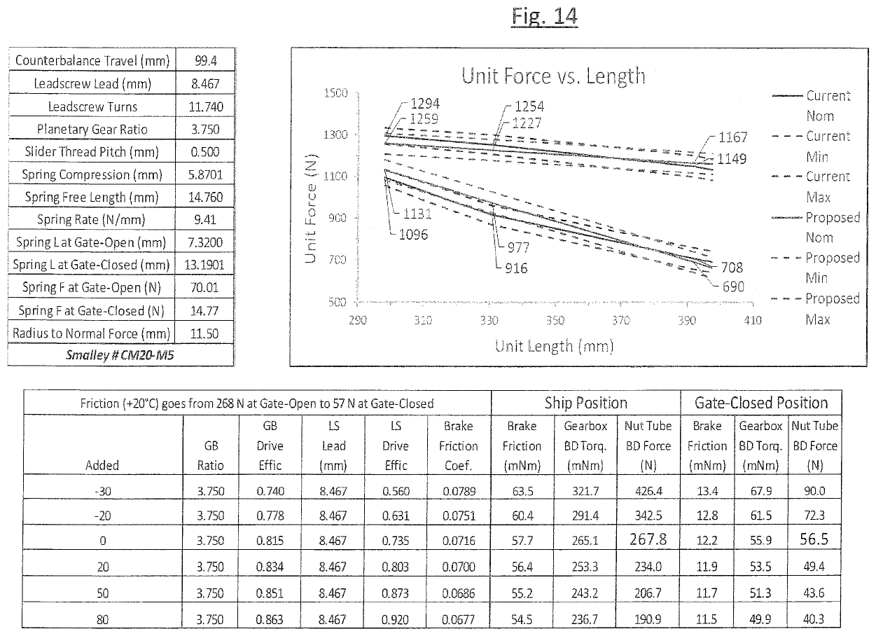

The counterbalance mechanism 15 can have a spring 42 (e.g. resilient element) mounted on a spring support tube 43 and covered by a spring cover tube 44 of the housing 41. The ball socket 38 is connected (e.g. welded) to a nut tube 45 at one end and a travel member 47 is connected (e.g. crimped via bushing 48) to the nut tube 45 at the other end. As such, as the travel member 47 travels along the lead screw 40 (along the axis 132), the nut tube 45 extends/retracts with respect to a cavity 48 of the spring support tube 43. As such, the nut tube 45 is one example of the extension member 35 of FIGS. 1-3. As such, the nut tube 45 is can be interchanged with the extension member 35 for exemplary purposes only. The travel member 47 (e.g. FIG. 14c) can be fixed (e.g. non-rotating about the axis 132 along the lead screw 40. It is recognized that the travel member 47 does not rotate around the lead screw 40, rather the travel member 47 travels linearly along the longitudinal axis 132 and linearly along a body of the lead screw 40 as the lead screw 40 rotates (is rotated) about the longitudinal axis 132, such that the travel member 47 has a threaded bore engaging the external threads of the lead screw 40.

The counterbalance mechanism 15 for the vehicle 10 includes the extensible extension member 35 and is connected by a pivot mount 36 (e.g. ball joint), located at a lower end of the housing 41, which can be pivotally mounted to a portion of the vehicle body 11 adjacent to an interior cargo area in the vehicle 10. A second pivot mount 38 (e.g. ball joint) is attached to the distal end of extensible extension member 35 and is pivotally mounted to the closure panel 14 of the vehicle 10.

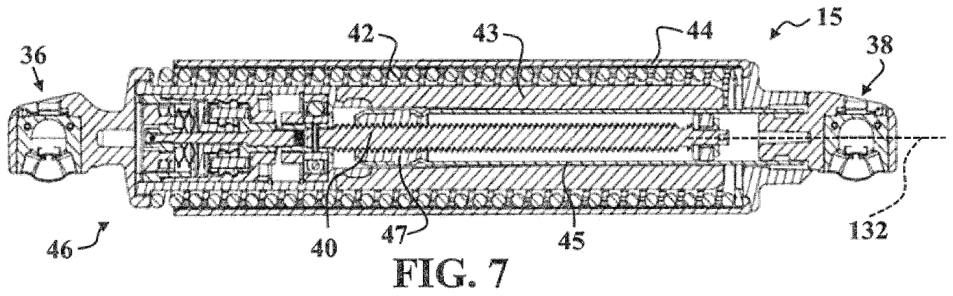

It is recognized that the spring 42, optional, can be used to assist in extension of the counterbalance mechanism 15, as desired. Referring to FIG. 7, shown is the counterbalance mechanism 15 in a contracted state (e.g. the closure panel 14 is closed—as depicted by the ghosted view of the closure panel 14 in FIGS. 1 and 2), as compared to FIG. 4A showing the counterbalance mechanism 15 in an expanded state (i.e. the closure panel is open—as depicted in FIGS. 1, 2, and 3).

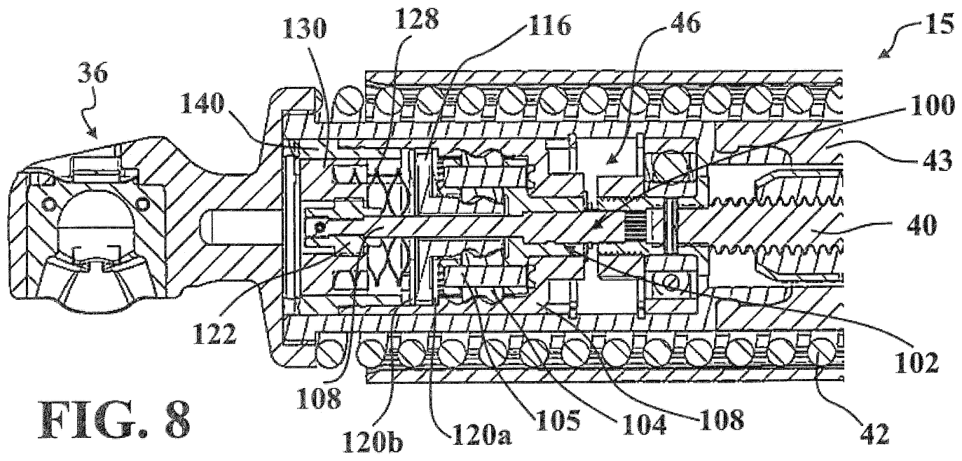

Referring to FIG. 8, shown is the variable friction mechanism 46 when the closure panel 14 is in the closed position. In this state, the variable friction mechanism 46 is at minimum friction being supplied between the friction body 117 of the pinion 116 and the washers 120a,b, as the slider body 130 is positioned farthest away from the washer 120b along the axis 132, thus placing the spring 128 in an extended state. Since the spring 128 is in the extended state, the force of the spring 128 driving the washer 120b (as well as the washer 120a) against the friction body 117 is also at a minimum. FIG. 8 is compared to FIG. 6, wherein the variable friction mechanism 46 is shown when the closure panel 14 is in the open position. In this state, the variable friction mechanism 46 is at maximum friction being supplied between the friction body 117 of the pinion 116 and the washers 120a,b, as the slider body 130 is positioned closest to the washer 120b along the axis 132, thus placing the spring 128 in a contracted state (as compared to the expanded state shown in FIG. 8). Since the spring 128 is in the contracted state, the force of the spring 128 driving the washer 120b (as well as the washer 120a) against the friction body 117 is also at a maximum.

Referring to FIG. 9, shown is the variable friction mechanism 46 coupled to the counterbalance mechanism 15 in perspective view.

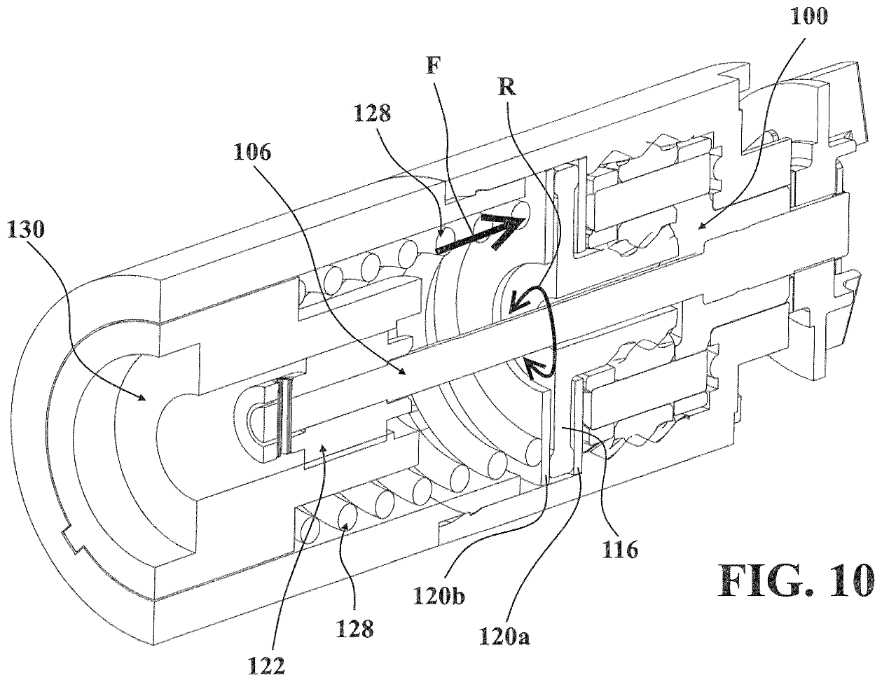

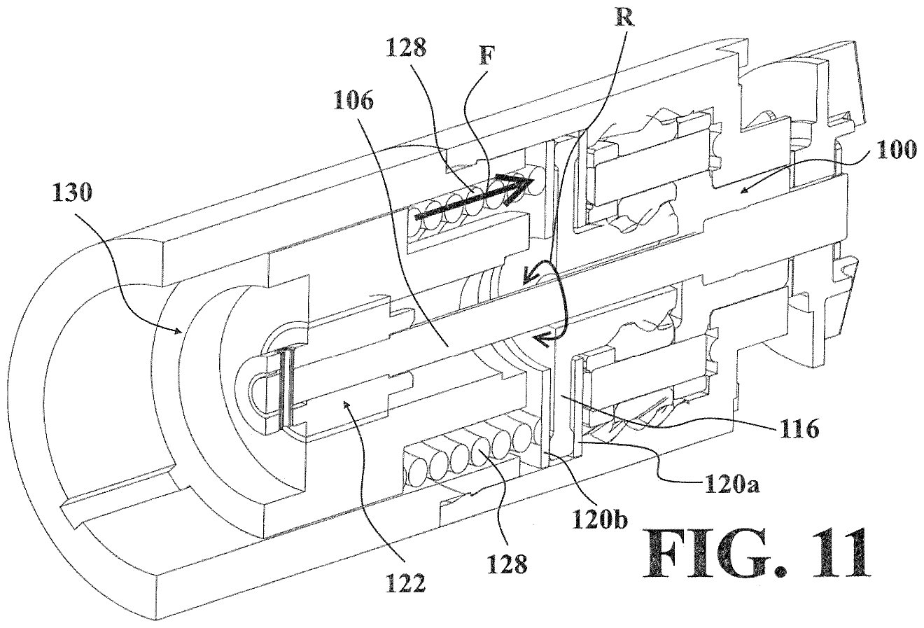

Referring to FIGS. 4, 6, 7, 8, operation of the counterbalance mechanism 15 is assisted by the variable friction mechanism 46, which changes (i.e. varies) the amount of friction generated by the friction body 117 between the pair of washers 120a,b as the lead screw 40 rotates about the axis 132. In example operation of closing of the closure panel 14 (e.g. from fully open to fully closed), the operator closes the closure panel 14 by pushing on the closure panel towards the closed position (e.g. ghosted view of the closure panel 14 in FIGS. 1,2). As the counterbalance mechanism is compressed, the travel member 47 is pushed along the axis 132 by the nut tube 45 (the optional spring 42 of the counterbalance mechanism 15 is compressed). As the travel member 47 moves (e.g. translates) towards the pivot mount 36, the lead screw 40 is rotated about the axis 132, which in turn rotates the carrier assembly 100, the shaft 106 and the coupling 122. The rotating carrier assembly 100 turns the gears 104 which rotate in the stationary ring gear 108, which in turn rotates R (see FIGS. 10 and 11) the pinion 116 according the planetary gear ratio established by the gears 104 in cooperation with the gear 118 of the pinion 116.

The pinion 116 rotates R relative to the washers 120a,b which have a normal force applied by the spring 128 that is compressed between the slider body 130 and the washer 120b. This normal force F (see FIGS. 10 and 11) creates a Friction Torque between the rotating friction body 117 of the pinion 116 and the stationary washers 120a,b positioned on either side of the friction body 117. As shown, one of the washers 120a is positioned adjacent to the carrier assembly 100 (mounted on the shaft 106) and the other washer 120b is positioned between the fiction body 117 and the spring 128. It is recognised that the Friction Torque can be multiplied through the planetary Gear Ratio between the pinion 116, the gears 104, and the ring gear 108, which is then multiplied through the lead screw 40 and the travel member 47 to provide a Linear Friction Force (or Stop-&-Hold function) that resists movement of the extension member 35 and therefore resists movement of the closure panel 14.

Further, the rotating coupling 122 turns relative to the slider body 130 via the threaded interface (meshed threads 124, 134). The slider body 130 can travel linearly but cannot rotate relative to the stationary cover 140. When the closure panel 14 is pushed in the close direction, this rotates the coupling 122 in the direction that moves the slider body 130 in the direction (e.g. towards the pivot mount 36) for less compression of the spring 128. Thus as the closure panel 14 closes, the friction torque between pinion 116 and washers 102a,b is reduced linearly until the closure panel 14 reaches the closure panel 14 “Closed position”. In the closed position, the spring 128 is at its least-compressed position, the Friction Torque is therefore at its minimum, and Stop-&-Hold force of the counterbalance mechanism 15 is therefore at its minimum.

In example operation of opening of the closure panel 14 (e.g. from fully closed to fully open), the operator opens the closure panel 14 by pulling on the closure panel towards the open position (see the closure panel 14 in FIGS. 1,2,3). As the counterbalance mechanism 15 is extended, the travel member 47 is pushed along the axis 132 by the nut tube 45 (the optional spring 42 of the counterbalance mechanism 15 is extended). As the travel member 47 moves (e.g. translates) away from the pivot mount 36, the lead screw 40 is rotated about the axis 132, which in turn rotates the carrier assembly 100, the shaft 106 and the coupling 122. The rotating carrier assembly 100 turns the gears 104 which rotate in the stationary ring gear 108, which in turn rotates R (see FIGS. 10 and 11) the pinion 116 according the planetary gear ratio established by the gears 104 in cooperation with the gear 118 of the pinion 116.

The pinion 116 rotates R relative to the washers 120a,b which have a normal force applied by the spring 128 that is compressed between the slider body 130 and the washer 120b. This normal force F (see FIGS. 10 and 11) creates a Friction Torque between the rotating friction body 117 of the pinion 116 and the stationary washers 120a,b positioned on either side of the friction body 117. As shown, one of the washers 120a is positioned adjacent to the carrier assembly 100 (mounted on the shaft 106) and the other washer 120b is positioned between the fiction body 117 and the spring 128. It is recognised that the Friction Torque can be multiplied through the planetary Gear Ratio between the pinion 116, the gears 104, and the ring gear 108, which is then multiplied through the lead screw 40 and the travel member 47 to provide a Linear Friction Force (or Stop-&-Hold function) that resists movement of the extension member 35 and therefore resists movement of the closure panel 14.

Further, the rotating coupling 122 turns relative to the slider body 130 via the threaded interface (meshed threads 124, 134). The slider body 130 can travel linearly but cannot rotate relative to the stationary cover 140. When the closure panel 14 is pushed in the open direction, this rotates the coupling 122 in the direction that moves the slider body 130 in the direction (e.g. away from the pivot mount 36) for more compression of the spring 128. Thus as the closure panel 14 opens, the friction torque between pinion 116 and washers 102a,b is increased (e.g. linearly) until the closure panel 14 reaches the closure panel 14 “Open position”. In the open position, the spring 128 can be at its most-compressed position, the Friction Torque can be therefore at its maximum, and Stop-&-Hold force of the counterbalance mechanism 15 can be therefore at its maximum.

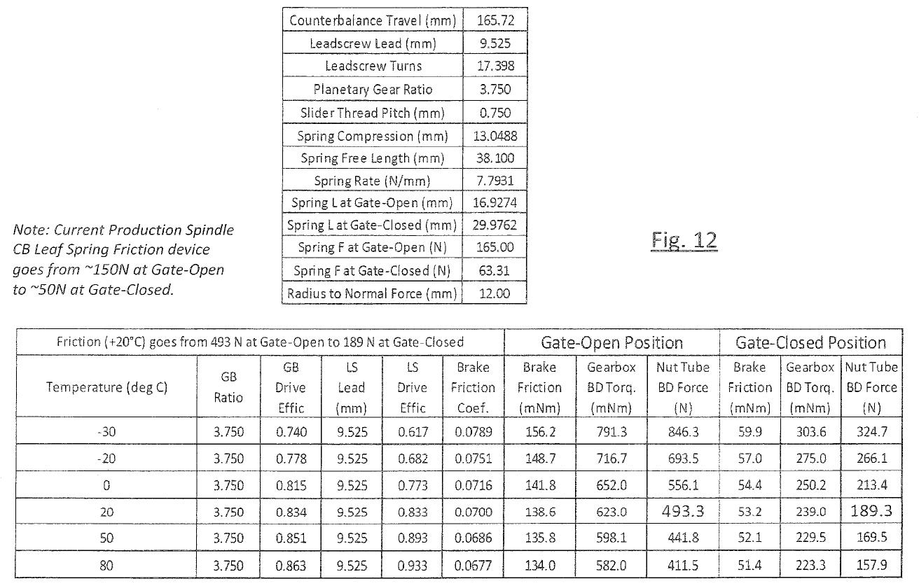

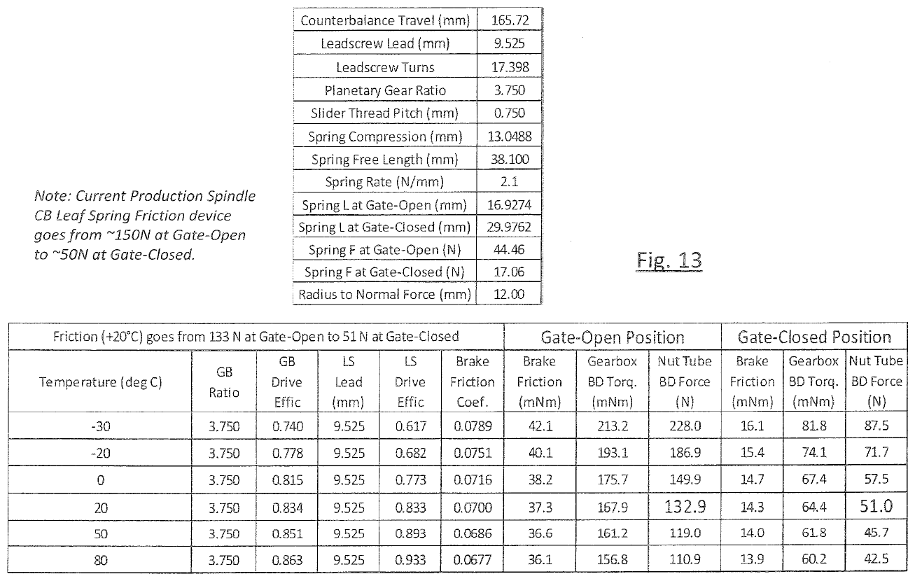

Referring to FIG. 12, shown is self-adjusting friction of the counterbalance mechanism 15 for a sample theoretical calculation—high friction. Referring to FIG. 13, shown is self-adjusting friction of the counterbalance mechanism 15 for a sample theoretical calculation—low friction. Referring to FIG. 14, shown is self-adjusting friction of the counterbalance mechanism 15 for a sample theoretical calculation—showing friction generated for a roof mounted closure panel 14.

As described above, the friction based counterbalance mechanism 15 is for coupling with the closure panel 14 of the vehicle 10 to assist in opening and closing of the closure panel 14. The counterbalance mechanism 15 can include: the housing 41 having the first pivot mount 36 for connecting to one of the body 11 of the vehicle 10 and the closure pane 14; the extension member 45 (also referred to as the rod 35 by example in FIGS. 1,2,3) coupled to the housing 41 and being extendable and retractable with respect to the housing 41, the extension member 45 for connecting by the second pivot mount 38 to the other of the body 11 and the closure panel 14; the variable friction mechanism 46 mounted in the housing 41 having the shaft 106 having the axis 132, the washer 120b positioned on the axis 132, the pinion 116 with the friction body 117 positioned on the shaft 106 and adjacent to the washer 120b, the pinion 116 rotatable about the axis 132 relative to the washer 120b during rotation of the shaft 106 to generate friction between the washer 120b and the friction body 117, the slider body 130 positioned on the axis 132; and the spring 128 positioned on the axis 132 between the slider body 130 and the washer 120b, such that the spring 128 exerts the force F (e.g. axial) on the washer 120b to force the washer 120b against the friction body 117; and the lead screw 40 coupled to the extension member 45 on one end and coupled to the shaft 106 on the other end, such that extension and retraction of the extension member 45 with respect to the housing 41 causes rotation of the lead screw 40 about the axis 132; wherein rotation of the lead screw 40 causes rotation of the shaft 106 to change the axial position of the slider body 130 on the axis 132 and thus a degree of compression of the spring 128 positioned between the slider body 130 and the washer 120b.

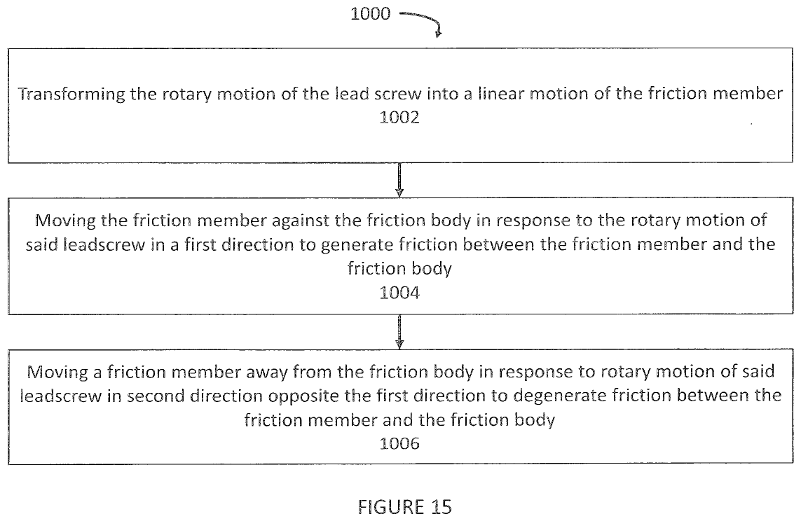

Now referring to FIG. 15, there is illustratively provided a method 1000 of controlling movement of a closure panel 14 of a vehicle 10 between an open position and a closed position with a counterbalance mechanism 15 (e.g. strut), the counterbalance strut having a housing 41 connected to one of the closure panel 14 or the body 11 of the vehicle 10 and having an inner surface 61 bounding a cavity 60 extending along a central axis 132 between opposite first and second ends, a leadscrew 40 disposed in said cavity, a planetary gearset 104,108 disposed in said cavity and comprising an output coupled with said leadscrew and an input coupled with the friction body 117, a friction member (e.g. washer 120b) moveable against the friction body 117, and a telescoping unit operably connected to the other of the closure panel 14 or the body of the vehicle 11, said telescoping unit having an extensible member 45 at least partially received in said cavity 60 through said second end of said housing 41 and having a drive nut (e.g. travel member 47) for converting linear motion of said telescoping unit between a retracted position relative to said housing 41 and an extended position relative to said housing 41 into rotary motion of said leadscrew 40.

The method 1000 includes transforming rotary motion of a lead screw 40 of the counterbalance mechanism into varying linear movement of the friction member 120b relative to the friction body 117 e.g. towards and away from. The method 1000 may include the steps of transforming 1002 the rotary motion of the lead screw 40 into a linearly (along the axis 132) applied bias of the friction member 120b with respect to the friction body 117, increasing 1004 the bias of the friction member 120b against the friction body 117 in response to the rotary motion of the leadscrew 40 in a first direction to increase friction between the friction member 120b and the friction body 117, decreasing 1006 the bias of the friction member 120b towards the friction body 117 in response to rotary motion of the leadscrew 40 in second direction opposite the first direction in order to degenerate friction between the friction member 120b and the friction body 117. It is recognized that the washer 120a can also be a friction member in order to generate friction in contact between the friction member 120a and the friction body 117, such that the friction generated between the friction member 120a and the friction body can also be subjected to the bias of the resilient element 128 (i.e. the friction generated between the fiction member 120a and the friction body 117 will increase for increasing bias and decrease for decreasing bias, as controlled by the axial position of the slider body 130 on the axis 132 with respect to the friction body 117).

1. A friction based counterbalance mechanism (15) for coupling with a closure panel (14) of a vehicle (10) to assist in opening and closing of the closure panel, the counterbalance mechanism including:
a housing (41) for connecting between a body (11) of the vehicle and the closure panel;
a variable friction mechanism (46) mounted in the housing having:
a shaft (106) having an axis (132);
a friction member (120b) positioned on the axis;
a pinion (116) with a friction body (117) positioned on the shaft and adjacent to the friction member, the pinion rotatable about the axis relative to the friction member during rotation of the shaft to generate friction between the friction member and the friction body; and
a slider body (130) positioned on the axis;
wherein rotation of the shaft changes an axial position of the slider body on the axis and thus a degree of engagement of the friction member against the friction body.

2. The friction based counterbalance mechanism of claim 1, further comprising:
a resilient element (128) positioned on the axis between the slider body and the friction body, such that the resilient element exerts a bias on the friction member to position the friction member against the friction body;
wherein rotation of the shaft changes an axial position of the slider body on the axis and thus a degree of compression of the resilient element positioned between the slider body and the friction body.

3. The friction based counterbalance mechanism of claim 2 further comprising a coupling (122) mounted on the shaft and adjacent to the slider body, the coupling for rotation with the shaft, the coupling in threaded engagement with the slider body such that rotation of the coupling causes the change in the axial position of the slider body on the axis.

4. The friction based counterbalance mechanism of claim 2 further comprising the bias as an axial force (F) for providing said position.

5. The friction based counterbalance mechanism of claim 1 further comprising a set of gears (104) coupled to the shaft for conjoint rotation with the shaft and a gear (118) mounted on the pinion, such that the set of gears and the gear are in threaded engagement with one another in order to cause the rotation of the pinion relative to the friction member.

6. The friction based counterbalance mechanism of claim 5, wherein the set of gears are mounted in a carrier (102) providing for said set of gears coupled to the shaft.

7. The friction based counterbalance mechanism of claim 1, wherein the housing has a first pivot mount (36) for connecting to one of the body of the vehicle and the closure panel and an extension member (45) coupled to the housing and being extendable and retractable with respect to the housing, the extension member for connecting by a second pivot mount (38) to the other of the body and the closure panel.

8. The friction based counterbalance mechanism of claim 7 further comprising a lead screw (40) coupled to the extension member on one end and coupled to the shaft on the other end, such that extension and retraction of the extension member with respect to the housing causes rotation of the lead screw about the axis, wherein rotation of the lead screw causes said rotation of the shaft; and a travel member (47) threadingly engaged with the lead screw, the travel member connected to the extension member, such that said extension and retraction of the extension member with respect to the housing causes translation of the travel member along the axis.

9. The friction based counterbalance mechanism of claim 7 further comprising a second resilient element (128) positioned in the housing between the shaft and the second pivot mount.

10. The friction based counterbalance mechanism of claim 1 further comprising a second friction member (120a) positioned on the axis and adjacent to the friction body and opposite to the friction member, such that the second friction member is also subject to the bias of the resilient element in order to force the friction member against the friction body.

11. The friction based counterbalance mechanism of claim 1, wherein the degree of engagement of the friction member against the friction body is greater when the closure panel (14) is in an open position than when the closure panel (14) is in a closed position.

12. A variable friction mechanism for mounting in a housing of a counterbalance mechanism for a closure panel of a vehicle, the variable friction mechanism including:
a shaft having an axis;
a friction member positioned on the axis;
a pinion with a friction body positioned on the shaft and adjacent to the friction member, the pinion rotatable about the axis relative to the friction member during rotation of the shaft to generate friction between the friction member and the friction body; and
a rotary to linear convertor having an input coupled to the shaft for receiving a rotation of the shaft and an output coupled to the friction member for moving the friction member relative to the pinion in response to receiving the rotation.

13. The variable friction mechanism of claim 12, wherein the rotary to linear convertor comprises:
a slider body positioned on the axis; and
a resilient element positioned on the axis between the slider body and the friction body, such that the resilient element exerts an axial force on the friction member to force the friction member against the friction body;
wherein rotation of the shaft about the axis changes an axial position of the slider body on the axis and thus a degree of compression of the resilient element positioned between the slider body and the friction body.

14. The variable friction mechanism of claim 13, further comprising a coupling mounted on the shaft and adjacent to the slider body, the coupling for rotation with the shaft, the coupling in threaded engagement with the slider body such that rotation of the coupling causes the change in the axial position of the slider body on the axis.

15. The variable friction mechanism of claim 13, further comprising a set of gears coupled to the shaft for conjoint rotation with the shaft and a gear mounted on the pinion, such that the set of gears and the gear are in threaded engagement with one another in order to cause the rotation of the pinion relative to the friction member.

16. The variable friction mechanism of claim 13, further comprising a set of gears (104) coupled to the shaft for conjoint rotation with the shaft and a gear (118) mounted on the pinion, such that the set of gears and the gear are in threaded engagement with one another in order to cause the rotation of the pinion relative to the friction member.

17. The variable friction mechanism of claim 16, wherein the set of gears are mounted in a carrier (102) providing for said set of gears coupled to the shaft.

18. A method for controlling movement of a closure panel of a vehicle between an open position and a closed position using a variable friction mechanism positioned in a counterbalance mechanism, the variable friction mechanism including a friction member positioned adjacent to a friction body, the method including the step of:
transforming rotary motion of a lead screw of the counterbalance mechanism into varying linear movement of the friction member relative to the friction body.

19. The method of claim 18, further comprising:
increasing a bias of the friction member against the friction body in response to a rotary motion of said lead screw in a first direction to increase a friction between the friction member and the friction body; and
decreasing the bias of the friction member against the friction body in response to the rotary motion of said lead screw in second direction opposite the first direction to decrease the friction between the friction member and the friction body.

20. The method of claim 19 further comprising moving a slider body (130) positioned on an axis of the variable friction mechanism by the rotary motion, wherein a resilient element (128) is positioned on the axis between the slider body and the friction body, such that the resilient element exerts the bias on the friction member to position the friction member against the friction body, wherein changes to an axial position of the slider body on the axis changes a degree of compression of the resilient element in order to provide said varying the applied bias.
